(19) United States
(12) Patent Application Publication
(10) Pub. No.: US 2018/0088416 A1
(43) Pub. Date: Mar. 29, 2018

(54) ARRAY SUBSTRATE AND METHOD FOR MANUFACTURING THE SAME, AND DISPLAY PANEL

(71) Applicants: BOE TECHNOLOGY GROUP CO., LTD., Beijing (CN); HEFEI XINSHENG OPTOELECTRONICS TECHNOLOGY CO., LTD, Hefei, Anhui (CN)

(72) Inventors: Liangliang Jiang, Beijing (CN); Lei Guo, Beijing (CN); Ke Dai, Beijing (CN); Yong-Jun Yoon, Beijing (CN); Feng Yang, Beijing (CN)

(21) Appl. No.: 15/522,752

(22) PCT Filed: May 3, 2016
(86) PCT No.: PCT/CN2016/080873

§ 371 Date: Apr. 27, 2017

(30) Foreign Application Priority Data
Feb. 19, 2016 (CN) 201610094872.8

(51) Int. Cl. G02F 1/1335; G02F 1/1343

(52) U.S. Cl. CPC G02F 1/133609; G02F 2001/134345; G02F 2001/133614; G02F 1/134309

(57) ABSTRACT

The present disclosure provides an array substrate and a method for manufacturing the same, as well as a display panel. The array substrate includes a light transmissive layer which is formed on and covers over the whole of a layer where a source-drain electrode pattern is located, and under excitation of first color light emitted from an external backlight source, and the light transmissive layer is configured to, under excitation of first color light emitted from an external backlight source, emit second-color light for forming white light.

### CROSS-REFERENCE TO RELATED APPLICATION

This application is a Section 371 National Stage Application of International Application No. PCT/CN2016/080873, filed on May 3, 2016, entitled “ARRAY SUBSTRATE AND METHOD FOR MANUFACTURING THE SAME, AND DISPLAY PANEL”, which in turn claims the benefit of Chinese Application No. 201610094872.8, filed on Feb. 19, 2016, both of which are incorporated herein by reference in their entirety.

### BACKGROUND OF THE DISCLOSURE

### Field of the Disclosure

Embodiments of the present disclosure generally relate to the field of display technology, and in particular, to an array substrate and a method for manufacturing the same, as well as a display panel.

### Description of the Related Art

Liquid crystal display (LCD) using a TFT (Thin Film Transistor) array is a passive luminescent flat-panel display device comprising a liquid crystal screen which itself is not luminous and may only realize normal display function by arranging a backlight source. As illustrated in FIG. 1, a schematic structural view of a liquid crystal display panel in prior art is shown in details, in which white light emitted from a backlight source passes through an array substrate 201, a liquid crystal layer 202 and a color filter (CF) substrate 203 and finally, respective sub-pixels emit three-color light, i.e., R/G/B (Red/Green/Blue) color light, respectively. When compared with a CRT (Cathode Ray Tube) display, the liquid crystal display has several advantages, such as relatively small thickness and relatively low power consumption. Therefore, the CRT display has been replaced by the LCD display in many fields.

As a passive luminescent display, the LCD display requires a backlight source which has a uniform luminance and is energy-efficient and relatively thinner and lighter. And since a white LED (Light Emitting Diode) has above necessary prominent advantages, it replaces the CCFL (Cold Cathode Fluorescent Lamp) technology gradually and becomes an overwhelming backlight source for the liquid crystal display nowadays. Still referring to FIG. 1, the LED mainly uses a Blue light chip 204 as an excitation source, on a surface of which a layer of phosphor powder material is applied, such as Y (YAG, i.e., yttrium aluminum garnet) powder, YR (Yellow Red) powder, RG (Red Green) powder, or the like. The layer of phosphor powder material is fixedly carried centrally on the Blue light chip. The Blue light chip emits blue light after being powered, and excites the phosphor powder material applied on the surface thereof, such that after color mixing, white light which has a spectrum covering the visible light region ranging from 380 nm to 780 nm is formed to function as the backlight. The white light emitted from the backlight source has its main emission peak existing at a sharp and narrow peak of blue color ranging from 440 nm to 450 nm and a wide peak of yellow color ranging from 500 nm to 650 nm, which correspond to an emission peak of the blue light chip after being powered and to the other emission peak of the phosphor powder material after being excited, respectively. The white light is firstly subject to adaption and adjustment of grey scale by the liquid crystal layer, then passes through the R/G/B color resistances on the surface of the colored filter, and finally presents an image with a controllable luminance and rich colors.

However, the present LED which adopts a structure consisting of the blue light chip and the phosphor powder material still has following questions: with limitation by both application process and accuracy, an uneven application of the phosphor powder on the surface of the blue light chip may be incurred, which may adversely influence both luminescence uniformity and spectrum stability of the phosphor powder material; besides, since the blue light chip may easily produce heat after being powered, the application of the phosphor powder material on the surface thereof is adverse to heat dissipation of the chip, while the service lives of the chip and the phosphor powder material are shortened, shortening the service life of the LED finally.

### SUMMARY

In view of the above, the present disclosure provides an array substrate and a method for manufacturing the same, as well as a liquid crystal display, enabling mitigation in aging due to heat generation of a blue light chip and a phosphor powder material.

On a basis of above purpose, the present disclosure provides an array substrate, comprising a light transmissive layer which is formed on and covers over the whole of a layer where a source-drain electrode pattern is located, the light transmissive layer is configured to, under excitation of first color light emitted from an external backlight source, emit second-color light for forming white light.

In one embodiment, the array substrate further comprises a pixel electrode layer which is formed on the light transmissive layer and comprises a red sub-pixel region, a green sub-pixel region and a blue sub-pixel region, the first-color light being blue light, portions of the light transmissive layer corresponding to the red sub-pixel region and the green sub-pixel region are doped with phosphor powder capable of emitting white light under excitation of blue light emitted from the external backlight source.

In one embodiment, a portion of the light transmissive layer corresponding to the blue sub-pixel region is doped with phosphor powder capable of emitting white light under excitation of the blue light emitted from the external backlight source.

In one embodiment, a portion of the light transmissive layer corresponding to the blue sub-pixel region is not doped with phosphor powder material and is configured to transmit therethrough the blue light emitted from the external backlight source.

In one embodiment, the light transmissive layer is formed by a transparent resin material.

Meanwhile, the present disclosure also provides a liquid crystal display panel, comprising the array substrate described in any one of embodiments of the disclosure.

In one embodiment, the liquid crystal display panel further comprises a color filter substrate which is arranged opposite to the array substrate and is provided with a red filter unit corresponding to the red sub-pixel region, a green filter unit corresponding to the green sub-pixel region and a blue filter unit corresponding to the blue sub-pixel region.

In one embodiment, in a case that in the array substrate, the portion of the light transmissive layer corresponding to the blue sub-pixel region is not doped with any phosphor powder material and is configured to transmit the blue light emitted by the external backlight source, the blue filter unit is configured to transmit completely the blue light emitted from the external backlight source.

In an exemplary embodiment, the liquid crystal display panel further comprises a blue backlight source.

In one embodiment, the blue backlight source is a blue light emitting diode.

In one embodiment, a surface of the blue light emitting diode is applied with a resin layer for heat conduction.

Furthermore, the present disclosure further provides a method for manufacturing an array substrate, comprising following steps: forming a thin-film transistor array on a glass substrate; forming a light transmissive layer on a layer where a source-drain electrode pattern of the thin-film transistor array is located, the light transmissive layer covering over the whole layer where the source-drain electrode pattern is located and configured to, under excitation of first color light emitted from an external backlight source, emit second-color light for forming white light; and forming a pixel electrode layer on the light transmissive layer, the pixel electrode layer comprising a red sub-pixel region, a green sub-pixel region and a blue sub-pixel region.

In an embodiment, the step of forming a light transmissive layer on a source-drain electrode pattern layer of the thin-film transistor comprises: applying onto the source-drain electrode pattern layer a transparent resin material which is doped with phosphor powder; and forming the light transmissive layer by removing a portion of the applied transparent resin material corresponding to the blue sub-pixel region through a patterning process.

In an embodiment, the step of forming a light transmissive layer on a source-drain electrode pattern layer of the thin-film transistor comprises: forming the light transmissive layer by applying onto the source-drain electrode pattern layer a transparent resin material which is doped with phosphor powder.

In an embodiment, the method further comprises forming a passivation layer between the source-drain electrode pattern layer and the light transmissive layer.

### BRIEF DESCRIPTION OF THE DRAWINGS

FIG. 1 is a detailed schematic structural view of a liquid crystal display panel in a prior art;

FIG. 2 is a detailed schematic structural view of an array substrate according to an embodiment of the disclosure;

FIG. 3 is a detailed schematic structural view of an array substrate according to another embodiment of the disclosure;

FIG. 4 is a detailed schematic structural view of an array substrate according to a further embodiment of the disclosure; and

FIG. 5 is a detailed schematic structural view of a liquid crystal display panel according to an embodiment of the disclosure.

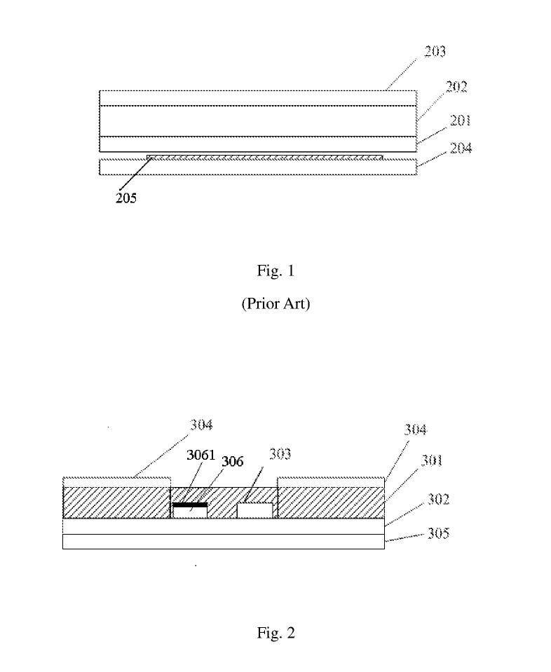

### DETAILED DESCRIPTION OF PREFERRED EMBODIMENTS

The present disclosure will be described in detail hereinafter in combination with exemplary embodiments with reference to the drawings, such that technical problems to be solved, technical solutions and advantages of the present disclosure will become more apparent.

According to a general technical concept of the present invention, there is provided an array substrate comprising a light transmissive layer which is formed on and covers over the whole of a layer where a source-drain electrode pattern is located, and the light transmissive layer is configured to, under excitation of first color light emitted from an external backlight source, emit second-color light for forming white light.

As can be seen from above, the array substrate provided by the disclosure is provided with a light transmissive layer which is capable of converting the light emitted from the external backlight source into white light without imposing any effect on luminescence effects. Meanwhile, the light transmissive layer is provided on the source-drain electrode pattern layer on the array substrate and away from a chip of a LED light which functions as the backlight source, so as to avoid heat dissipation of the chip from being adversely affected and to enhance service life of the chip. Moreover, the light transmissive layer may also functions as a passivation layer (PVX).

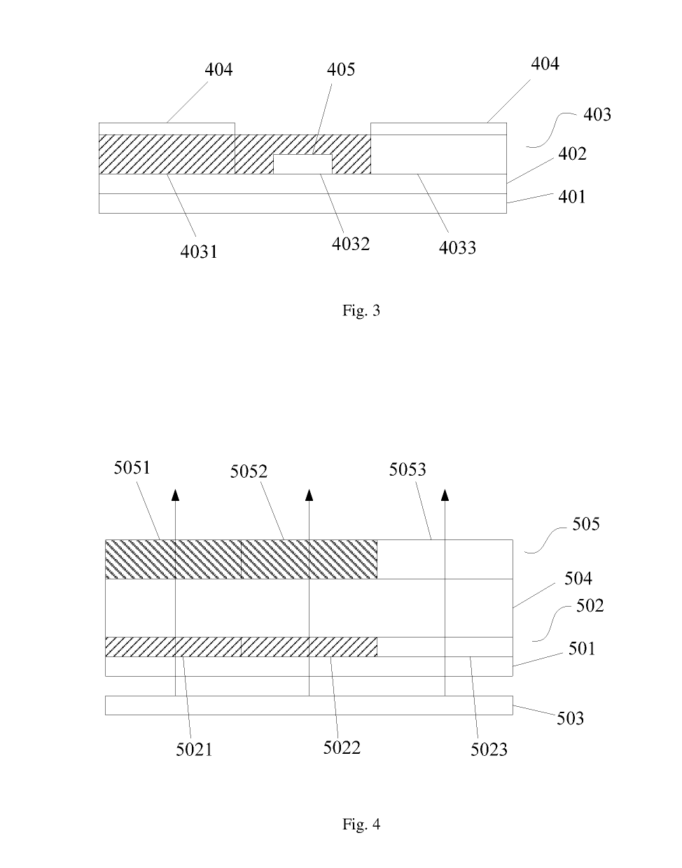

It is generally required to manufacture a prior art array substrate through a patterning process such as lithography process, including preparing structures such as a gate, an active layer, S/D (Source/Drain) electrodes, a SiNx (silicon nitride) passivation layer and a pixel electrode (Pixel ITO) and so on. In an embodiment of the disclosure, as illustrated in FIG. 2, phosphor powder may be firstly doped or filled within a material (e.g., a transparent resin material) used for forming the light transmissive layer 301, and then the light transmissive layer 301 may be formed onto the array substrate (to be specific, by way of example, onto a source-drain electrode pattern layer located on the array substrate or onto a passivation layer located on the source-drain electrode pattern layer), the light transmissive layer 301 is positioned on a glass substrate 305 on which a gate insulation layer 302, a thin-film transistor array 306 (comprising a source-drain electrode pattern 3061 provided on a top layer thereof) and a data line 303 are formed, while a pixel electrode layer 304 is provided on the light transmissive layer 301. As illustrated in FIG. 3, the light transmissive layer 301 takes the place of the passivation layer on the array substrate in the prior art, therefore neither preparation processes nor processing cost of the array substrate would be increased. However, as can be easily appreciated by those skilled in the art, in another embodiment, as shown in FIG. 3, a passivation layer 307 may be provided and the light transmissive layer 301 may be provided on the passivation layer 307.

In an embodiment, the array substrate may further comprises a pixel electrode layer (e.g., a pixel electrode layer 304) which is formed on the light transmissive layer 301 and comprises a red sub-pixel region, a green sub-pixel region and a blue sub-pixel region, the first-color light being a blue light; and portions of the light transmissive layer corresponding to the red sub-pixel region and the green sub-pixel region are doped with phosphor powder capable of emitting white light under excitation of blue light emitted by the external backlight source.

According to a general technical concept of the present disclosure, there is further provided a method for manufacturing an array substrate, comprising following steps: forming a thin-film transistor array on a glass substrate; forming a light transmissive layer on an electrode pattern layer where a source-drain electrode pattern of the thin-film transistor array is located, the light transmissive layer covering over the whole layer where the source-drain electrode pattern is located and configured to under excitation of first color light emitted from an external backlight source, emit second-color light for forming white light; and forming a pixel electrode layer on the light transmissive layer, the pixel electrode layer comprising a red sub-pixel region, a green sub-pixel region and a blue sub-pixel region. In an exemplary embodiment of the disclosure, a metal layer (e.g., Al or Mo) having a predetermined thickness is deposited by a sputtering process onto a surface of the glass substrate 305 so as to function as a gate pattern layer, and then a gate pattern is formed by processes including coating photoresistor, exposure, development, acid etching and the like. Thereafter, through a PECVD (i.e., Plasma Enhanced Chemical Vapor Deposition) process, a layer of SiNx is deposited on the surface of the glass substrate 305 on which the gate pattern is formed, so as to form the gate insulation layer 302. Then, a metal layer (e.g., Al or Mo) is deposited by a sputtering process and the source/drain electrode pattern 3061 is formed by processes including coating photoresistor, exposure, development, acid etching and the like. Next, another layer of SiNx is deposited on the surface of the substrate by the PECVD process so as to form an insulation layer, and then a pattern of passivation layer corresponding to the blue sub-pixel region is formed by processes including coating photoresistor, exposure, development, dry etching and the like. A layer of photosensitive organic resin doped with yellow phosphor powder is coated onto the surface of the substrate by a coating apparatus, and patterns of the red and green sub-pixel regions are left by exposure and development, so as to form a composite insulation layer which includes the organic resin containing the yellow phosphor powder and the passivation layer. Finally, subsequent film layers including pixel electrodes are deposited. As to a color filter substrate which is arranged to aligned with and opposite to the array substrate, a layer of black matrix is coated onto the surface of the color filter substrate by coating apparatus, and then is subject to exposure and development processes so as to form black matrix patterns corresponding to R/G/B sub-pixels; and in regions on the surface of the color filter substrate corresponding to red, green, blue color display regions, R/G/W (red/green/white) color resistor patterns are formed sequentially, by coating a photosensitive organic resin by coating apparatus, and through exposure and development by means of a mask. A pure blue light LED is adopted as the backlight module, and the blue light emitted therefrom pass through the insulation layers of the array substrate: the blue light which passes through the red and green sub-pixel regions are absorbed by the phosphor powder to emit white light, and the white light continues to pass through a conventional liquid crystal layer which controls display of grey scales and then is subject to color filtration of both red and green color resistors on the surface of the color filter substrate to emit red and green light; while the blue sub-pixel region is provided therein a white organic resin layer which is configured for decreasing the difference in level on the color filter substrate and is capable of emitting blue light which will pass through the liquid crystal layer controlling display of grey scales; finally a full-color display of red, green and blue may be achieved, with a greatly enhanced overall transmittance of the blue sub-pixel and thus of the liquid crystal display panel.

In other embodiments of the disclosure, the patterns of the red and green sub-pixel regions are manufactured firstly, and then the pattern of the passivation layer corresponding to the blue sub-pixel region is manufactured.

In exemplary embodiments of the disclosure, the second-color light may be white light, or monochromatic light which is to form the white light through color combination.

In some exemplary embodiments of the disclosure, the array substrate comprises a red sub-pixel region, a green sub-pixel region and a blue sub-pixel region, the first-color light is blue light, and portions of the light transmissive layer corresponding to the red sub-pixel region and the green sub-pixel region are doped with phosphor powder capable of emitting white light under excitation of the blue light emitted by the external backlight source.

Since the phosphor powder is doped into the light transmissive layer, then a uniform distribution thereof in the light transmissive layer may be obtained by a doping process, such that both luminescence uniformity and spectrum stability of first light emitted from the backlight source after conversion may be increased and thus the display effect may also be enhanced. Meanwhile, since the phosphor powder is located away from the light-emitting chip, then a shortened service life of the phosphor powder material due to heat generation thereof may be avoided, thereby the service lives of both the blue light chip and the phosphor powder are increased.

In some embodiments of the disclosure, a portion of the light transmissive layer corresponding to the blue sub-pixel region is doped with phosphor powder capable of emitting white light under excitation of the blue light emitted by the external backlight source.

In another embodiment of the disclosure, the portion of the light transmissive layer corresponding to the blue sub-pixel region is not doped with any phosphor powder and is capable of transmitting therethrough the blue light emitted by the external backlight source. As illustrated in FIG. 4, a gate insulation layer 402, a light transmissive layer 403 and a pixel electrode 404 are provided sequentially on a base substrate 401, and the light transmissive layer 403 comprises a region 4031 corresponding to a red sub-pixel, a region 4032 corresponding to green sub-pixel, and a region 4033 corresponding to a blue sub-pixel. The region 4031 corresponding to red sub-pixel and the region 4032 corresponding to green sub-pixel are doped with the phosphor powder, while the region 4033 corresponding to the blue sub-pixel is not doped with any phosphor powder and is capable of transmitting therethrough the blue light emitted by the external backlight source. A data line 405 is arranged between the light transmissive layer 403 and the gate insulator layer 402. Similar to FIG. 2, the thin-film transistor array (comprising the source-drain electrode pattern layer arranged at a top portion thereof) may be disposed adjacent to the data line 405 and covered by the light transmissive layer 403, and such thin-film transistor array is omitted in FIG. 4 for simplification purpose.

As the backlight source in prior art, a blue light chip is adopted, on a surface of which the phosphor powder is applied, with following questions: Firstly, a relatively large portion of the blue light emitted from the blue light chip is used to excite the phosphor powder, thus resulting in a relatively large loss of the blue light. Secondly, the white light of the backlight source is mainly formed by both the blue light excited by power-up and a luminescence spectrum of the phosphor powder excited by such blue light, but transmittances of R:G:B color resistors provided with a same film thickness in a liquid crystal display panel may be approximately 3:9:1 and light absorbance of the blue color resistor is larger than that of either the red or the green color resistor, resulting in not only a significantly decreased luminance of the blue light after various passes but also a relatively large loss of the backlight white light after passing through the blue color resistor, which (in combination with a fact that human eyes themselves are insensitive to the blue light) may result in a relatively low transmittance of the blue light, which becomes a key factor restricting improvement of the overall transmittance of the liquid crystal panel, thereby resulting in a relatively low overall transmittance of the panel and an increased power consumption of the backlight source. Therefore, how to enhance both the transmittance and luminance of the blue sub-pixels is crucial in improving the transmittance of the liquid crystal panel.

According to the embodiments of the present disclosure, the portion of the light transmissive layer located in blue sub-pixel region on the array substrate is manufactured from a transparent material which is capable of transmitting therethrough blue light directly, thereby decreasing loss and correspondingly enhancing the transmittance ratio of the blue light. Therefore, a light transmittance of the display panel which adopts the array substrate according to the embodiments of the disclosure may also be increased.

In some embodiments of the disclosure, the light transmissive layer is formed by a transparent resin material.

In an exemplary embodiment of the disclosure, upon manufacturing of the array substrate, the phosphor powder is firstly stirred uniformly with a transparent organic resin monomer, such as PMMA (Polymethyl Methacrylate) or PC (Polycarbonate) at a certain proportion; and then a gate layer (metal layer), a GI (gate insulation) layer, an active layer and a source-drain electrode pattern layer are formed on the surface of the glass substrate and ready for use; the transparent organic resin mixed with the phosphor powder is coated onto the substrate; and the array substrate coated with the resin is dried, exposed, developed, and dried again; and finally pixel electrodes are formed by a patterning process.

Meanwhile, the present disclosure also provides a liquid crystal display panel comprising the array substrate described in any one of the embodiment of the disclosure.

In an exemplary embodiment of the disclosure, the array substrate and the colored filter substrate are assembled into a panel through a vacuum laminating process after being filled with liquid crystal therebetween, and correspondingly, a pure blue light LED is used as a backlight source. Phosphor powder, such as Y powder, YR powder or R/G powder, is filled into the transparent organic resin, and the resin is provided onto the glass substrate of the array substrate by a patterning process such as lithography, so as to function as a passivation layer, instead of traditional SiNx or SiO2 material. The passivation layer is replaced by the light transmissive layer, such that the structure of the liquid crystal display panel may be simplified. By the liquid crystal display panel provided in the disclosure, a doping uniformity of the phosphor powder into the light transmissive layer may be improved, so as to overcome the uniformity problem of application of the phosphor powder material in the backlight source of the liquid crystal display panel in the prior art.

In some embodiments of the disclosure, the liquid crystal display panel further comprises a color filter substrate, which is arranged opposite to the array substrate and is provided with a red filter unit corresponding to the red sub-pixel region, a green filter unit corresponding to the green sub-pixel region and a blue filter unit corresponding to the blue sub-pixel region.

In some embodiments of the disclosure, when the portion of the light transmissive layer corresponding to the blue sub-pixel region of the array substrate is not doped with any phosphor powder and is capable of transmitting therethrough the blue light emitted from the external backlight source, the blue filter unit may transmit completely the blue light emitted from the backlight source. As illustrated in FIG. 5, a light transmissive layer 502 is provided on an array substrate 501, a portion 5021 of the light transmissive layer 502 corresponding to the red sub-pixel region, and a portion 5022 of the light transmissive layer 502 corresponding to the green sub-pixel region are doped with the phosphor powder, while a portion 5023 of the light transmissive layer 502 corresponding to the blue sub-pixel region is not doped with any phosphor powder. The blue light emitted from the backlight source 503 passes through a liquid crystal layer 504 and a color filter substrate 505 to exit, and a red filter unit 5051 and a green filter unit 5052 filters the white light generated after transmission through the light transmissive layer 502, while a blue filter unit 5053 transmits completely the blue light emitted from the backlight source 503.

In an embodiment, the liquid crystal display panel according to the disclosure further comprises a blue backlight source.

Furthermore, the present disclosure provides a liquid crystal display, comprising the liquid crystal display panel described in any one of the embodiments of the disclosure.

In some embodiments of the disclosure, the blue backlight source comprises a blue light emitting diode.

Upon preparation of the insulation layers of the array substrate in case the liquid crystal display panel is illuminated by the pure blue light LED used as the backlight source, the passivation layer or a transparent organic resin is deposited within the blue sub-pixel region, while the red and green sub-pixel regions are formed by organic resin filled with Y phosphor powder, for converting the blue light into the white light spectrum, so as to avoid loss in the prior art which is caused due to first conversion of the blue light from the backlight source into the white light and to subsequent conversion of the white light into the blue light by the color filter substrate. With the present disclosure, not only the transmittance of the blue sub-pixel and the panel may be greatly increased without narrowing color gamut of the panel, but also the problem of insufficient luminescence of the blue sub-pixel in the panel may be overcome. In order to decrease difference in level of sub-pixels on the surface of the color filter substrate and to alleviate defects such as friction scratches and the like, a white transparent resin is coated onto the blue sub-pixel region such that the blue light emitted by the backlight may pass through the color filter substrate after adaption and adjustment of the grey scale by the liquid crystal layer, so as to enhance both the luminance and the transmittance to a large extent; and various color resistor layers corresponding to the red sub-pixel region and the green sub-pixel region are manufactured on the color filter substrate, such that white light emitting from below may be filtered by the red and green color resistor in corresponding regions to emit normal red and green light after adaptation and adjustment of the grey scale by the liquid crystal layer.

In following tables 1 and 2, stimulation results of the color gamut of the liquid crystal panel according to exemplary embodiments of the disclosure are illustrated, where table 1 shows stimulation results of the color gamut of a liquid crystal panel in the prior art, while table 2 shows stimulation results of the color gamut of a liquid crystal panel according to exemplary embodiments of the disclosure. After comparison of the stimulation results, some conclusions are obtained as below: In the simulation of the color gamut of a liquid crystal panel in the prior art, conventional blue light chip in combination with phosphor powder is used to produce backlight, conventional passivation layer is used as the insulation layer(s) of the array substrate and corresponding R/G/B sub-pixels are periodically arranged on the color filter substrate, such that the color gamut value of 72.3% may be simulated under NTSC (National Television Standards Committee) standard, with Wx=0.313, Wy=0.325, CCT=6523 and the luminance being normalized to be 9.23, where Wx is a chromaticity coordinate of the white light along X axis, Wy is a chromaticity of the white light along Y axis, Y is a relative value of the luminance simulation while CCT is a Correlated Color Temperature. In the simulation of the color gamut of the liquid crystal panel according to the exemplary embodiments of the disclosure, conventional blue light LED is used to produce backlight, while a composite layer consisting of a passivation layer in combination with an organic resin doped with the phosphor powder is used as the insulation layer(s) of the array substrate and corresponding R/G/B sub-pixels are applied with red, green and white color resistors on the color filter substrate, such that the color gamut value of 72.3% may be obtained through simulation under NTSC (National Television Standards Committee) standard, with Wx=0.316, Wy=0.311, CCT=6458 and the luminance being normalized to be 18.6 which is increased by almost one time, such that high transmittance and high luminance may be obtained without adversely influencing the color gamut of the panel.

TABLE 1

| Color Resistor | R | G | B | W |
|---|---|---|---|---|
| Thickness/um | 2.0 | 2.0 | 2.0 | |
| x | 0.640 | 0.323 | 0.153 | 0.313 |
| y | 0.337 | 0.625 | 0.053 | 0.325 |
| Y | 5.6 | 20.2 | 1.9 | 9.23 |

| | | | |
|---|---|---|---|
| CCT | 6523 | Color Gamut | 72.82% |

TABLE 2

| Color Resistor | R | G | B | W |
|---|---|---|---|---|
| Thickness/um | 2.0 | 2.0 | 2.0 | |
| x | 0.635 | 0.323 | 0.157 | 0.316 |
| y | 0.332 | 0.621 | 0.057 | 0.311 |
| Y | 5.6 | 20.2 | 30 | 18.6 |

| | | | |
|---|---|---|---|
| CCT | 6458 | Color Gamut | 73.7% |

As can be seen from above, the array substrate provided by the disclosure may overcome the problem of unevenly applied phosphor powder on a conventional backlight source without increasing any manufacturing process and mask cost of the array substrate. In the array substrate according to the present disclosure, an organic resin which contains phosphor powder is coated onto a surface or surfaces of the glass substrate and is distributed evenly thereon so as to enhance both luminescence uniformity and spectrum stability greatly, such that both luminescence uniformity and spectrum stability of the phosphor powder are enhanced greatly after excitation by the blue light; further, the heat dissipation of the chip is also facilitated hereby so as to enhance stability of both the blue light chip and the phosphor powder and to increase service life of the chip. In the array substrate provided by the embodiments of the disclosure, the light transmissive layer may be manufactured from an organic resin material containing phosphor powder by a patterning process such as lithography for replacing the passivation layer; doping the liquid organic resin material with the phosphor powder can enhance both the distribution uniformity and luminescence effects of the phosphor powder greatly. The phosphor powder is located away from the chip which may produce heat, such that its service life may be increased correspondingly and thus both luminescence uniformity and service life of the backlight source may be enhanced significantly.

It should be appreciated for those skilled in this art that the above embodiments are only intended for illustrative, but not for limit the present disclosure. Embodiments and features described therein of the present application may be randomly combined with each other in case of not conflicting in configuration or principle.

Apparently, it would be appreciated by those skilled in the art that various changes or modifications may be made to the present disclosure without departing from the principles and spirit of the disclosure and are intended to be included within the scopes of present invention, which are defined in the claims and their equivalents.

1. An array substrate, comprising a thin-film transistor array formed on a base substrate and having a source-drain electrode pattern layer, and a light transmissive layer which is formed on and covers over the whole of the source-drain electrode pattern layer,
wherein the light transmissive layer is configured to, under excitation of first-color light emitted from an external backlight source, emit second-color light for forming white light.

2. The array substrate according to claim 1, further comprising a pixel electrode layer which is formed on the light transmissive layer and comprises a red sub-pixel region, a green sub-pixel region and a blue sub-pixel region, the first-color light being blue light,
wherein portions of the light transmissive layer corresponding to the red sub-pixel region and the green sub-pixel region are doped with phosphor powder capable of emitting white light under excitation of the blue light emitted from the external backlight source.

3. The array substrate according to claim 2, wherein a portion of the light transmissive layer corresponding to the blue sub-pixel region is doped with phosphor powder capable of emitting white light under excitation of the blue light emitted from the external backlight source.

4. The array substrate according to claim 2, wherein a portion of the light transmissive layer corresponding to the blue sub-pixel region is not doped with phosphor powder material and is configured to transmit therethrough the blue light emitted from the external backlight source.

5. The array substrate according to claim 1, wherein the light transmissive layer is formed by a transparent resin.

6. A liquid crystal display panel, comprising the array substrate according to claim 1.

7. The liquid crystal display panel according to claim 6, further comprising:
a pixel electrode layer, which is formed on the light transmissive layer and comprises a red sub-pixel region, a green sub-pixel region and a blue sub pixel region, the first-color light being blue light, portions of the light transmissive layer corresponding to the red sub-pixel region and the green sub-pixel region being doped with phosphor powder capable of emitting white light under excitation of the blue light emitted from the external backlight source; and
a color filter substrate which is arranged opposite to the array substrate and is provided with a red filter unit corresponding to the red sub-pixel region, a green filter unit corresponding to the green sub-pixel region and a blue filter unit corresponding to the blue sub-pixel region.

8. The liquid crystal display panel according to claim 6, further comprising a blue backlight source.

9. The liquid crystal display panel according to claim 8, wherein the blue backlight source comprises a blue light emitting diode.

10. The liquid crystal display panel according to claim 8, wherein a surface of the blue light emitting diode is coated with a resin layer for heat conduction.

11. A method for manufacturing an array substrate, comprising following steps:
forming a thin-film transistor array on a base substrate; and
forming a light transmissive layer on a source-drain electrode pattern layer of the thin-film transistor array, the light transmissive layer covering over the whole layer where the source-drain electrode pattern is located and configured to, under excitation of first-color light emitted from an external backlight source, emit second-color light for forming white light.

12. (canceled)

13. The method according to claim 11, wherein the step of forming the light transmissive layer on the source-drain electrode pattern layer of the thin-film transistor comprises:
forming the light transmissive layer by applying onto the source-drain electrode pattern layer a transparent resin material which is doped with phosphor powder.

14. The method according to claim 13, further comprising:
forming a passivation layer between the source-drain electrode pattern layer and the light transmissive layer.

15. The liquid crystal display panel according to claim 7, wherein a portion of the light transmissive layer corresponding to the blue sub-pixel region is doped with phosphor powder capable of emitting white light under excitation of the blue light emitted from the external backlight source.

16. The liquid crystal display panel according to claim 7, wherein a portion of the light transmissive layer corresponding to the blue sub-pixel region is not doped with phosphor powder material and is configured to transmit therethrough the blue light emitted from the external backlight source.

17. The method according to claim 11, further comprising:
forming a pixel electrode layer on the light transmissive layer, the pixel electrode layer comprising a red sub-pixel region, a green sub-pixel region and a blue sub-pixel region.

18. The method according to claim 17, wherein the step of forming the light transmissive layer on the source-drain electrode pattern layer of the thin-film transistor comprises:
applying onto the source-drain electrode pattern layer a transparent resin material which is doped with phosphor powder; and
forming the light transmissive layer by removing a portion of the applied transparent resin material corresponding to the blue sub-pixel region through a patterning process.

19. The method according to claim 17, wherein a portion of the light transmissive layer corresponding to the blue sub-pixel region is doped with phosphor powder capable of emitting white light under excitation of the blue light emitted from the external backlight source.

20. The method according to claim 17, wherein a portion of the light transmissive layer corresponding to the blue sub-pixel region is not doped with phosphor powder material and is configured to transmit therethrough the blue light emitted from the external backlight source.
